(19) United States
(12) Patent Application Publication
(10) Pub. No.: US 2024/0060869 A1
(43) Pub. Date: Feb. 22, 2024

(54) CAPACITIVELY DETERMINING QUANTITY OF PARTICULATE PRESENT IN A CHAMBER

(71) Applicant: Microchip Touch Solutions Limited, Wokingham (GB)

(72) Inventor: Colin Greaves, Manchester (GB)

(21) Appl. No.: 18/451,640

(22) Filed: Aug. 17, 2023

Related U.S. Application Data
(60) Provisional application No. 63/371,724, filed on Aug. 17, 2022.

(51) Int. Cl. G01N 15/06

(52) U.S. Cl. CPC G01N 15/0656

(57) ABSTRACT

An example relates to a method that includes capacitively determining a quantity of particulate present in an internal chamber of a housing structure while the housing structure receives a feed air stream to the internal chamber; and providing a value representing the measured quantity of particulate.

### CROSS-REFERENCE TO RELATED APPLICATION

This application claims the benefit under 35 U.S.C. § 119(e) of U.S. Provisional Patent Application Ser. No. 63/371,724, filed Aug. 17, 2022, entitled “SENSING QUANTITY OF PARTICULATE WITHIN A CHAMBER UTILIZING CAPACITIVE SENSING,” the disclosure of which is hereby incorporated herein in its entirety by this reference.

### FIELD

One or more examples relate, generally, to capacitive sensing or measurement. One or more examples relate, generally, to material quantity sensing or measurement. One or more examples relate, generally, to capacitively determining quantity of particulate present in a chamber. One or more examples relate, generally, to capacitively determining quantity of aerated particulate present in a chamber.

### BACKGROUND

Dust and other particulate may accumulate, intentionally or unintentionally, within structures. For example, various consumer appliances that remove dirt, dust and other particulate from surfaces or surrounding environment collect particulate within a container or an internal enclosure. As a further example, particulate may collect in the hollows of pipes, ducts, and other fluid conveyance structures. It may be desirable to detect that a quantity of particulate in a space or hollow is above a threshold.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a system for sensing quantity of particulate (static or aerated) in a chamber, in accordance with one or more examples.

FIG. 2 is a block diagram depicting an apparatus to generate a self-capacitance value in accordance with one or more examples.

FIG. 3A, FIG. 3B, and FIG. 3C are diagrammatic views of example orientations of an electrode positioned on external surface of a housing structure, in accordance with one or more examples. In the depicted XYZ coordinate references, for convenience of description the x-axis corresponds to a horizontal width of the depicted housing structure or external surface area, and the z-axis corresponds to a vertical height of the depicted housing structure or external surface area. Other conventions may be utilized without exceeding the scope of this disclosure.

FIG. 4A, FIG. 4B, FIG. 4C and FIG. 4D are diagrammatic views of example geometries exhibited by volumes of internal chambers of housing structures, in accordance with one or more examples.

FIG. 5 is a flow diagram depicting a process to determine a quantity of particulate present in an internal chamber of a housing structure, in accordance with one or more examples.

FIG. 6 is a flow diagram depicting a process to measure capacitance of an electrode coupled to a housing structure as part of a process to capacitively determine a quantity of particulate present in an internal chamber of the housing structure, in accordance with one or more examples.

FIG. 7 is a flow diagram depicting a process to capacitively determine a quantity of particulate present in an internal chamber of a housing structure, in accordance with one or more examples.

FIG. 8 is a flow diagram depicting a process to determine a state of an internal chamber or housing structure, in accordance with one or more examples.

FIG. 9 is a flow diagram depicting a process to determine a state of a feed air stream based on quantity of particulate, in accordance with one or more examples.

FIG. 10 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

Capacitive sensors may be used in a variety of operational contexts, for example, for capacitive proximity sensing, distance sensing, material level sensing, and material quantity sensing, without limitation.

Self-capacitance may be utilized to infer information about a material-of-interest. Self-capacitance is a capacitance of an electrode to a virtual ground, and such virtual ground may or may not be known. When the self-capacitance of an electrode is measured, it is typically with respect to a voltage signal that has a local ground as a reference potential, and the signal serves as an indication of the self-capacitance of the electrode or a magnitude of a variation therein. There may be variations in a coupling between an electrode and a virtual ground, which affects self-capacitance and indications of the self-capacitance of the electrode, and such variations may or may not be known. As a non-limiting example, if an electrode is coupled to a material-of-interest, there may be electrical coupling of the material-of-interest to an Earth potential or a local ground of a capacitive sensor due to an environment factors (e.g., objects that touch a material or a device-under-test in which the material is present, without limitation), which may affect the self-capacitance, and indications of self-capacitance, of an electrode.

Self-capacitance and indications thereof (hereinafter collectively referred to as “self-capacitance”) of an electrode changes in a generally predictable manner (e.g., proportionally, without limitation) when contacted by an object, an object draws closer to or farther from the electrode, or a material property of the object changes such as a dielectric property, without limitation. Non-limiting examples of dielectric properties include dielectric geometry (e.g., thickness or width of a material, without limitation) and dielectric material characteristic (i.e., a characterization of energy absorption from an electric field). In the case of a material that includes two or more different types of materials, a dielectric property of a material may change in response to a change in respective dielectric properties of first and second component materials, or in response to a change in ratio of respective quantities of first and second component materials.

The inventor of this disclosure appreciates that aerated particulate within a chamber acts like an object in proximity to an electrode positioned on an external surface of a structure at least partially defining the chamber. Such aerated particulate effects self-capacitance of the electrode in a reliably observable manner. One or more dielectric properties of aerated particulate may change proportionally in response to a change in quantity of particulate comprising the aerated particulate. As a non-limiting example, a dielectric material characteristic of the aerated particulate may change proportionally in response to a change in quantity of particulate comprising the aerated particulate.

Value of self-capacitance of the electrode may correspond to the quantity of particulate comprising the aerated particulate, and may change proportionally in response to change in quantity of particulate comprising the aerated particulate.

The inventor of this disclosure appreciates that self-capacitance of an electrode may be utilized to infer information about quantity of particulate comprising aerated particulate in a chamber. Sufficient magnitude of change of self-capacitance may be utilized as an indication of change from a first state of particulate (e.g., quantity of particulate at or below a predetermined threshold, without limitation) to a second state of particulate (e.g., quantity of particulate above the predetermined threshold, without limitation).

“Aerated” refers to air or another gas (collectively referred to herein as “air”) being introduced into a chamber, causing the particles to become suspended or dispersed within the air. An aeration processes involves mixing air with a particulate material.

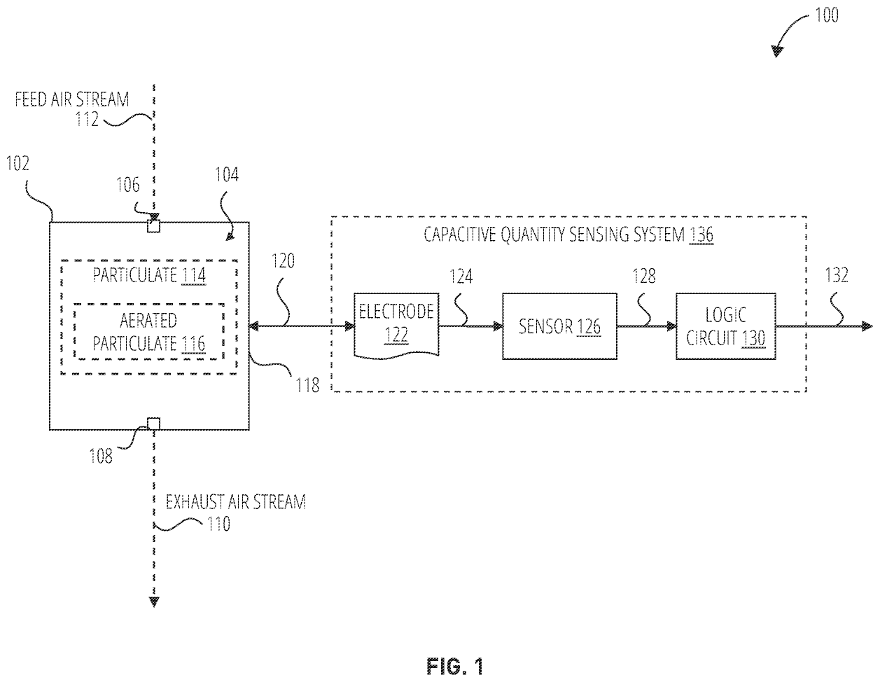

FIG. 1 is a block diagram depicting a system 100 for sensing a quantity of aerated particulate in a chamber, in accordance with one or more examples.

In one or more examples, particulate present within a chamber may be aerated or non-aerated (non-aerated is also referred to herein as “static”).

In one or more examples, a portion of particulate present within a chamber may be aerated and a portion of particulate within the chamber may be non-aerated.

System 100 includes: a housing structure 102 and capacitive quantity sensing system 136. Capacitive quantity sensing system 136 includes an electrode 122, a sensor 126, and a logic circuit 130.

Housing structure 102 may be a case, container, enclosure, other enclosing structural element, or portion thereof capable of defining a chamber within. Housing structure 102 at least partially defines internal chamber 104. Housing structure 102 includes at least two ports: first port 106 to receive a feed air stream 112, and, optionally, a particulate carried therewith (e.g., carried via frictional force, without limitation), and a second port 108 to send or expel an exhausted feed air stream 110. The particulate carried by the feed air stream 112 may be referred to as “feed particulate,” and the particulate already present in the chamber, if any, may be referred to herein as “chamber particulate.” When feed particulate is added to chamber particulate then the quantity of chamber particulate increases.

Non-limiting examples of first port 106 and second port 108 include apertures, a valve structure, conduit structures, or combinations thereof, without limitation. In cases where first port 106 is a valve structure, the valve structure controls/regulates the flow of feed air stream 112 into internal chamber 104. Such a valve structure may be utilized to regulate the size of feed particulate permitted to enter internal chamber 104 or the quantity of feed particulate permitted to enter internal chamber 104. In some cases, such a valve structure may operate as a safety or shut-off mechanism to shut off feed air stream 112 in case of abnormal or other conditions that might damage operation or otherwise reduce performance of system 100.

Housing structure 102, first port 106, or second port 108 may be operable to be coupled to any suitable sources for providing feed air stream 112 or expelling exhausted feed air stream 110 compatible with operating conditions.

Housing structure 102 may direct feed air stream 112, and feed particulate carried therewith, to internal chamber 104. Housing structure 102 may contain and hold particulate 114 within internal chamber 104. Particulate 114 may be or include aerated particulate 116, non-aerated particulate (e.g., static, without limitation), or both aerated and non-aerated particulate. Accordingly, at any given moment in time, housing structure 102 may contain and hold particulate 114 as static particulate, aerated particulate 116, or both static and aerated particulate within internal chamber 104.

Aerated particulate 116 of particulate 114 may be aerated by feed air stream 112. Feed particulate may be continuously or intermittently received during one or more a periods of time at internal chamber 104 and added to particulate 114 and aerated particulate 116 via feed air stream 112.

Feed air stream 112 may exhibit at least two states: active (e.g., flow rate of air into internal chamber 104 above a threshold, which threshold may be greater than or equal to zero, without limitation) or inactive (e.g., flow rate of air into internal chamber 104 below a threshold, which threshold may be greater than or equal to zero, without limitation). Feed air stream 112 may be continuous during a period of time (i.e., exhibiting active state for a totality of the period of time) or non-continuous during a period of time (i.e., exhibiting both active and inactive states during a totality of the period of time). The state of feed air stream 112 may at least partially be based on the specific operating environment of system 100.

If aeration of particulate 114 ceases (i.e., particulate is not actively aerated by feed air stream 112 or one or more other air streams, without limitation) for a period of time, housing structure 102 may contain and hold, within internal chamber 104, static particulate of particulate 114 that previously was aerated particulate 116. If aeration starts or resumes at housing structure 102 via feed air stream 112 for a period of time, some, or a totality of the particulate 114 in internal chamber 104 may become aerated particulate 116. Thus, in some instances, aerated particulate 116 may include newly received feed particulate and chamber particulate present in internal chamber 104 prior to starting feed air stream 112.

In some instances, at least a portion of particulate 114 may not be aerated when feed air stream 112 is active. As a non-limiting example, internal chamber 104 may be configured to circulate feed air stream 112 so that feed air stream 112 may move in a cyclonic path (e.g., a circular spiraling path, without limitation) within internal chamber 104. While the feed air stream 112 follows the cyclonic path, the inertia of particulate heavier than the air molecules of feed air stream 112 overcomes the frictional forces between the air molecules and the heavier particles (heavier than air molecules), and the heavier particles eventually collide with an interior surface of housing structure 102, and under the force of gravity accumulate or pile at a bottom or support surface of internal chamber 104. Thus, during a contemplated operation, at a given moment in time: a totality of particulate within internal chamber 104 may be aerated and move substantially with feed air stream 112; a portion of particulate within internal chamber 104 may be aerated and move substantially with feed air stream 112 and another, different, portion of particulate within internal chamber 104 may not move substantially with feed air stream 112 (e.g., static, falling under force of gravity, without limitation); or a totality of particulate within internal chamber 104 may not move substantially with feed air stream 112.

The particulate material of particulate 114 may be uniform or non-uniform (e.g., a mixture of two or more different particulate materials, without limitation). Individual particulate materials may exhibit different size, shape, density, or mass. The differences may contribute to why, in some instances, some particulate 114 is aerated particulate 116 and some particulate 114 is static particulate.

In one or more examples, housing structure 102 may operate as a conduit that contains and holds particulate of feed air stream 112 at least momentarily and directs feed air stream 112 and particulate carried therewith from a first region of housing structure 102 to a second, different, region of housing structure 102.

Housing structure 102 may exhibit any shape (e.g., a tubular shape, a quadrilateral shape, a spherical shape, a semi-spherical shape, a cylindrical shape, a semicylindrical shape, truncated versions thereof, or an irregular shape, without limitation) and size capable of containing and holding feed air stream 112 and particulate carried therewith, for example, in a circulating or linear in movement pattern there within. Housing structure 102 may be formed of and include any non-conductive material (e.g., glass, a non-conductive or suitably conductively-inhibited alloy, polymer, ceramic, composite, or combination thereof, without limitation) compatible with operating conditions (e.g., temperature, weight, air pressure, air flow rate, without limitation). The material of housing structure 102 does not include conductive material or includes only a negligible amount of conductive material because conductive material may negatively affect a capacitive measurement discussed below.

A volume of internal chamber 104 is at least partially defined by housing structure 102 and may exhibit any shape (e.g., a tubular shape, a quadrilateral shape, a spherical shape, a semi-spherical shape, a cylindrical shape, a semicylindrical shape, truncated versions thereof, or an irregular shape (i.e., asymmetrical shape), without limitation). In one or more examples, a suitable shape and size of a volume of internal chamber 104 may be chosen for an application in which system 100 is utilized.

Capacitive quantity sensing system 136 determines, utilizing capacitive sensing, a quantity of a particulate present in internal chamber 104 and generates a value representative of the determined quantity. As indicated above, capacitive quantity sensing system 136 includes electrode 122, sensor 126 and logic circuit 130.

Electrode 122, sensor 126 and logic circuit 130 co-operate to determine a quantity, or derivatives thereof, of particulate present in internal chamber 104 of housing structure 102. More specifically, electrode 122, sensor 126 and logic circuit 130 co-operate to measure self-capacitance (e.g., measure an absolute self-capacitance, measure a difference in self-capacitance from a baseline self-capacitance, or measure a change in self-capacitance over a time duration, or any combination thereof, without limitation) of electrode 122, and determine a value 132 representative of quantity of particulate present within internal chamber 104 at least partially responsive to the self-capacitance measurement of electrode 122. Value 132 may also be referred to herein a “quantity value 132.” Logic circuit 130 may provide the determined quantity value 132 to other circuitry, or to a user.

Electrode 122 may be formed of and include a mass of any conductive material (e.g., metal, alloy, conductive polymer (e.g., a semiconductor, without limitation), conductive ceramic, or combination thereof, without limitation). In one or more examples, electrode 122 is coupled 120 with external surface 118 of housing structure 102. In one or more examples, electrode 122 may be affixed to external surface 118 of housing structure 102. In one or more examples, electrode 122 may be formed in a material of housing structure 102 (e.g., embedded via a molding process, without limitation) with a connection structure (e.g., a conductive pad, conductive contact, or conductive wire, without limitation) exposed at external surface 118 or otherwise accessible externally and suitable for an electrical connection with sensor 126. In one or more examples, electrode 122 may be affixed to an internal surface of housing structure 102 and electrically connected to capacitive quantity sensing system 136 via an electrically conductive connection such as a metal wire, without limitation.

In one or more examples, electrode 122 may exhibit an elongated shape such as a strip having a long narrow portion of substantially uniform width and thickness, without limitation. When coupled with housing structure 102—whether affixed to external surface 118, affixed to an internal surface of housing structure 102, or embedded in a material of housing structure 102—electrode 122 may be positioned, arranged, or located with a longest length (e.g., the long narrow portion of a strip, without limitation) exhibiting any orientation with respect to housing structure 102.

An optional grounded conductive material (not depicted) may be coupled (e.g., affixed on external surface 118 of housing structure 102, or formed in a material of housing structure 102, which material of housing structure 102 may be the same or different material than electrode 122 is formed in, if at all, without limitation) with housing structure 102 to provide ground coupling with particulate 114 and aerated particulate 116, but is not required.

Sensor 126 determines, utilizing a self-capacitance measurement process, a self-capacitance of electrode 122 (e.g., an exhibited self-capacitance 124 of electrode 122) and generates a value 128 representative of self-capacitance 124 of electrode 122. Value 128 may also be referred to herein as “self-capacitance value 128.”

In one or more examples, exhibited self-capacitance 124 may be exhibited in response to sensor 126 performing a specific, predetermined, self-capacitance measurement process utilizing electrode 122, as discussed in one or more examples, below. Sensor 126 generates self-capacitance value 128 in response to performing the measurement process. In one or more examples, self-capacitance value 128 may be directly relatable to an actual self-capacitance of electrode 122 or directly relatable to a change from a baseline self-capacitance of electrode 122 that may be the same or different than the actual self-capacitance of electrode 122.

Logic circuit 130 determines a value 132 representative of a quantity of particulate 114 (static or aerated, or a combination thereof) present within internal chamber 104 of housing structure 102, and as indicated above may provide the determined quantity value 132 to other circuitry, or to a user. Logic circuit 130 determines quantity value 132 at least partially based on self-capacitance value 128 and a predetermined relationship between self-capacitance values and quantity of aerated particulate. In one or more examples, various predetermined relationships with self-capacitance values may be utilized by logic circuit 130. Non-limiting examples of predetermined relationships include: a predetermined relationship between exhibited self-capacitance value 128 and a weight or mass of particulate 114 (static or aerated); or a predetermined relationship between exhibited self-capacitance value 128 and an amount (e.g., percentage or ratio, without limitation) of a volume of internal chamber 104 of housing structure 102 occupied by particulate 114 (static or aerated, or a combination thereof).

In an example where the predetermined relationship is between a weight or mass of particulate 114 and self-capacitance value 128, logic circuit 130 may determine weight or mass of particulate present in the internal chamber 104 at least partially based on the predetermined relationship and self-capacitance value 128, and quantity value 132 may represent the determined weight or mass. In an example where the predetermined relationship is between an occupied volume of internal chamber 104 and self-capacitance value 128, logic circuit 130 may determine a volume of particulate 114 present in the internal chamber 104 at least partially based on the predetermined relationship and self-capacitance value 128, and quantity value 132 may represent the determined volume.

Quantity value 132 may be provided or made available to a downstream user, as non-limiting examples, a threshold detector that determines a state of internal chamber 104 or housing structure 102 by comparing quantity value 132 to one or more predetermined threshold values (e.g., not full, full, without limitation); or a controller for a consumer appliance, where the controller provides status information about quantity of particulate present in internal chamber 104 or notifications about actions to be taken with respect to particulate present in internal chamber 104 (e.g., empty the particulate from internal chamber 104, without limitation).

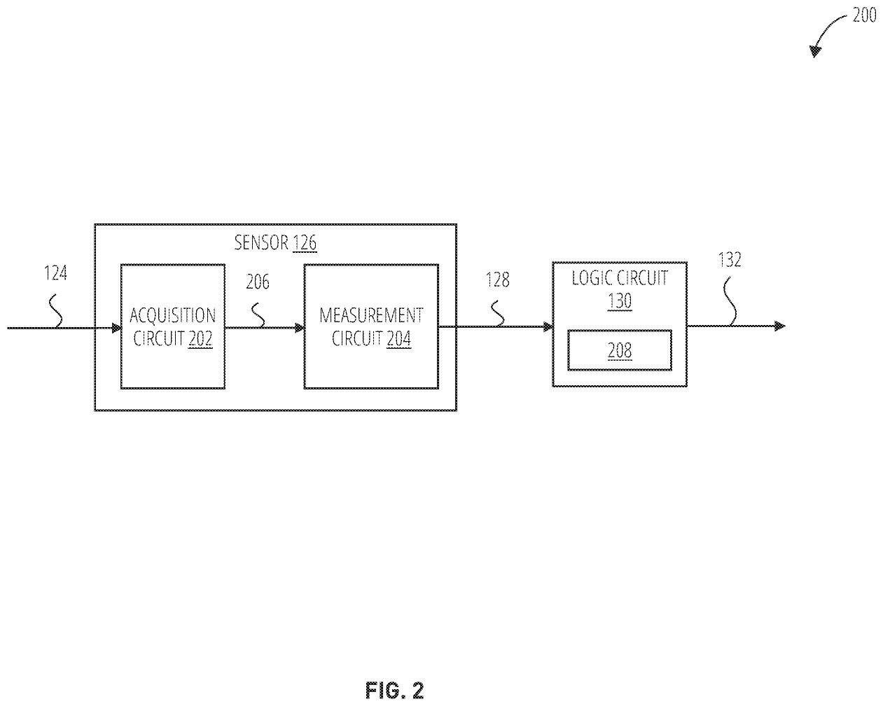

FIG. 2 is a block diagram depicting an apparatus 200 to generate a self-capacitance value 128 in accordance with one or more examples. Apparatus 200 is a non-limiting example of sensor 126 or sensor 126 and logic circuit 130. Apparatus 200 includes sensor 126, which includes acquisition circuit 202 and measurement circuit 204.

Acquisition circuit 202 generates internal voltage 206 that is indicative of exhibited self-capacitance 124 of electrode 122. More specifically, internal voltage 206 is generated exhibiting a voltage level indicative of exhibited self-capacitance 124 in response to acquisition circuit 202 performing a specific acquisition process. An increase or decrease of the voltage level of internal voltage 206 should reflect a respective proportional increase or decrease in exhibited self-capacitance 124.

A non-limiting example of a suitable acquisition process is a capacitive voltage divider (CVD) type self-capacitance measurement, which generates internal voltage 206 on an internal sample-and-hold capacitor (internal capacitor not depicted). A CVD type measurement utilizes a capacitive-voltage-divider circuit, where, if the electrode 122 and an internal circuit of sensor 126 are respectively charged to predetermined voltages and then share charge, a resultant voltage at an internal capacitor (e.g., internal voltage 206, without limitation) is indicative of self-capacitance, or change in self-capacitance, at electrode 122. A further non-limiting example of a suitable acquisition process is a charge-transfer or charge distribution type self-capacitance measurement, which converts an amount of charge signal indicative of self-capacitance or change in self-capacitance to a voltage signal.

Measurement circuit 204 may generate self-capacitance value 128, which is a digital representation of a voltage level of internal voltage 206 or a value derived from a voltage level of internal voltage 206. As non-limiting examples, measurement circuit 204 may include an analog-to-digital converter (ADC) to generate a digital value representative of a voltage level of internal voltage 206. In one or more examples, the digital value representative of a voltage level of internal voltage 206 may represent exhibited self-capacitance 124 of electrode 122 or may be scaled or changed by a predetermined amount or function to a value representative of exhibited self-capacitance 124.

Logic circuit 130 includes predetermined relationship 208 to relate self-capacitance value 128, and exhibited self-capacitance 124 indirectly, to a quantity of particulate 114 (static or aerated), as discussed above. In one or more examples, predetermined relationship 208 may be defined in logic of logic circuit 130 to calculate a quantity value of particulate at least partially based on self-capacitance value 128, such an algorithm or function, without limitation. Additionally or alternatively, predetermined relationship 208 may be defined in one or more tables, such as a look-up-table (LUT) that associates self-capacitance values with quantity values and optionally logic for interpolating quantity values based on self-capacitance values that are between specified self-capacitance values and associated quantity values. Logic circuit 130 may utilize self-capacitance value 128 to identify and/or interpolate a quantity value for quantity value 132.

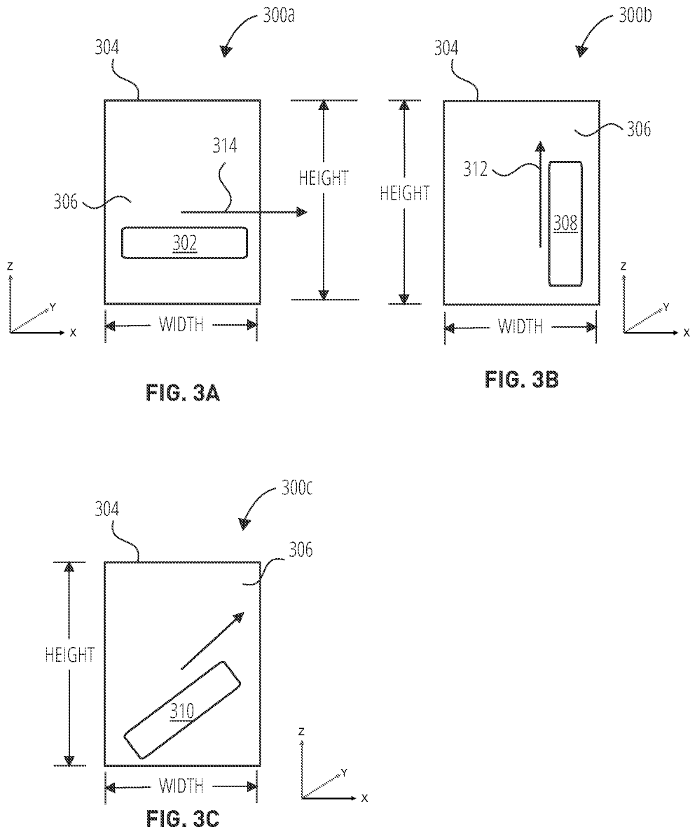

FIG. 3A, FIG. 3B, and FIG. 3C are diagrammatic views of example orientation 300a, orientation 300b, and orientation 300c, respectively, of electrode 308 positioned as non-limiting examples, at a wall 306 of housing structure 304 (e.g., on a surface of wall 306 that corresponds to an external surface of housing structure 304, on a surface of wall 306 that corresponds to an internal surface of housing structure 304, or embedded in a material of wall 306, without limitation). An xyz coordinate reference is used to describe the orientations depicted by FIG. 3A, FIG. 3B and FIG. 3C. In FIG. 3A, FIG. 3B and FIG. 3C, the x-axis corresponds to a width of the wall 306 of the housing structure 304 and the z-axis corresponds to a height of the wall 306 of the housing structure 304. “Height” and “width” of wall 306 of housing structure 304 depends on, as non-limiting examples, the specific operating conditions and applications.

FIG. 3A depicts an example orientation 300a where an electrode 302 is positioned at wall 306 to orient a longest length of the electrode 302 in a direction 314 parallel to a width of the housing structure 304 and perpendicular to a height of the housing structure 304. A direction of a central longitudinal axis of electrode 302 is aligned with the x-axis of depicted xyz coordinate reference. In a case where housing structure 304 exhibits a substantially circular cross section, the longest length of the electrode 302 is perpendicular to the height of the housing structure 304.

FIG. 3B depicts an example orientation 300b where an electrode 308 is positioned at wall 306 to orient a longest length of the electrode 308 in a direction 312 parallel to a height of the housing structure 304 and perpendicular to a width of the housing structure 304. A direction of a central longitudinal axis of electrode 308 is aligned with a z-axis of depicted xyz coordinate reference.

FIG. 3C depicts an example orientation 300c where the electrode 310 is positioned at wall 306 to orient a longest length of the electrode 310 in a direction 316 at an angle with respect to height and width of the housing structure. A direction of a central longitudinal axis of electrode 310 is aligned at an angle that bisects the x-axis and z-axis of the depicted xyz coordinate reference. In a case where housing structure 304 exhibits a substantially circular cross section, the direction of the central longitudinal axis of electrode 310 is aligned at an angle that bisects the x-axis, y-axis and z-axis of the depicted xyz coordinate reference.

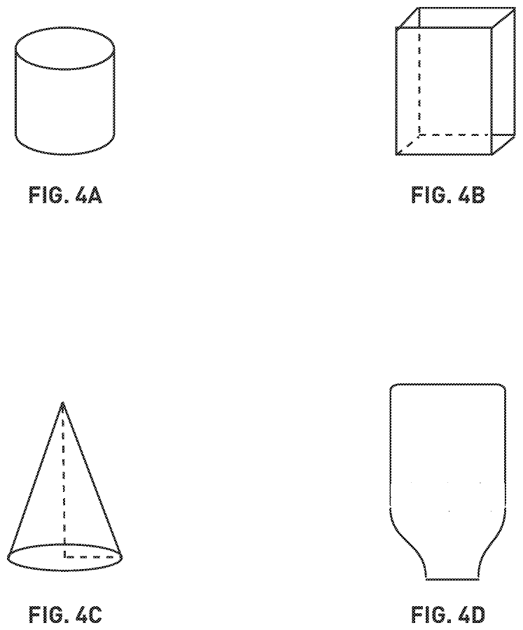

FIG. 4A, FIG. 4B, FIG. 4C and FIG. 4D are diagrammatic views of example geometries of volumes defined by internal chamber 104 of housing structure 102. FIG. 4A depicts an example where the internal chamber 104 defines a volume having a cylindrical geometry. FIG. 4B depicts an example where the internal chamber 104 defines volume having a rectangular geometry. FIG. 4C depicts an example where the internal chamber 104 defines a volume having a generally cone shaped geometry. FIG. 4D depicts an example where the internal chamber 104 defines a volume having an irregular geometry, and more specifically, a generally cubic geometry concatenated with a generally tapered geometry.

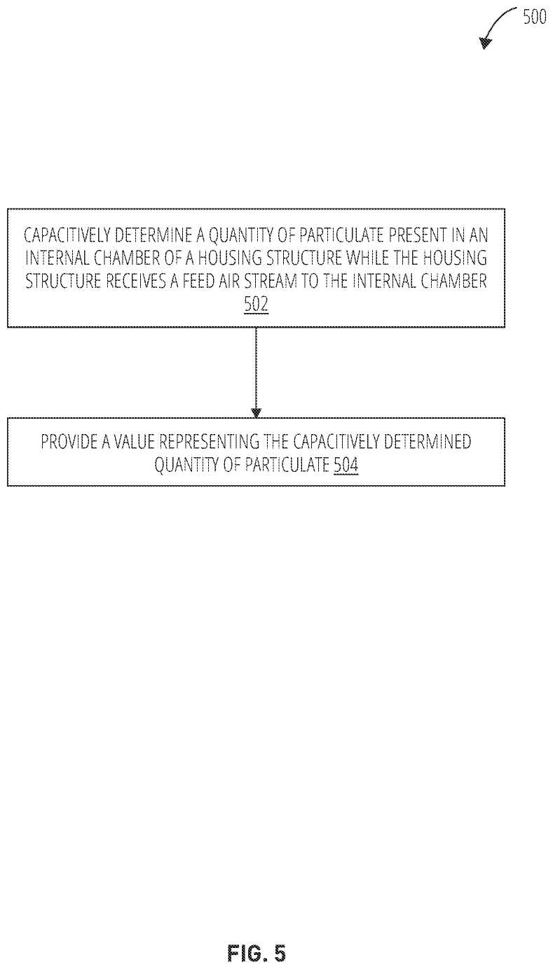

FIG. 5 is a flow diagram depicting a process 500 to determine a quantity of particulate present in an internal chamber of a housing structure, in accordance with one or more examples. Some or a totality of operations of process 500 may be performed, as a non-limiting example, by capacitive quantity sensing system 136 of system 100.

Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

According to one or more examples, the process 500 includes capacitively determine a quantity of particulate present in an internal chamber of a housing structure while the housing structure receives a feed air stream to the internal chamber at operation 502.

According to one or more examples, the process 500 includes providing a value representing the capacitively determined quantity of particulate at operation 504 (e.g., a quantity value, without limitation).

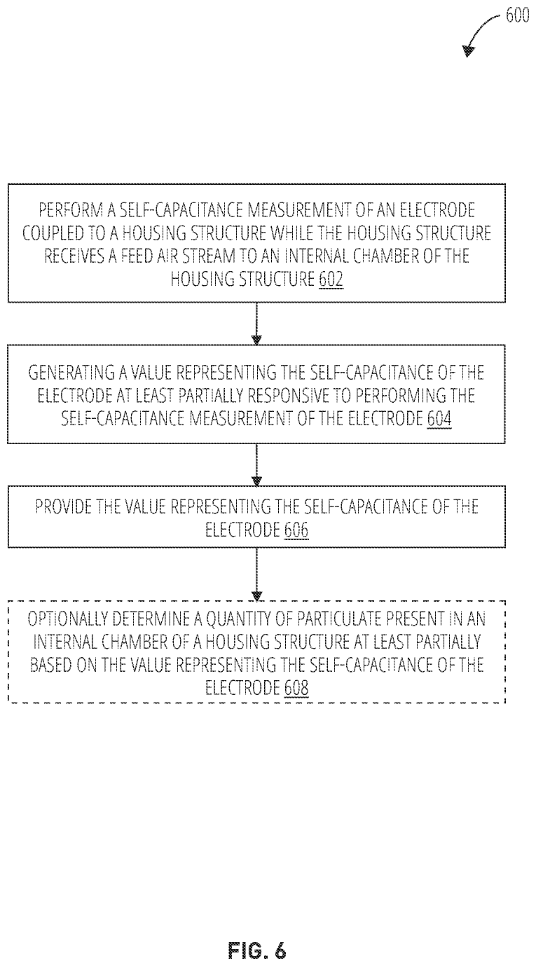

FIG. 6 is a flow diagram depicting a process 600 to measure capacitance of an electrode coupled to a housing structure as part of a process to capacitively determine a quantity of particulate present in an internal chamber of the housing structure, in accordance with one or more examples. Some or a totality of operations process 600 may be performed, as a non-limiting example, by acquisition circuit 202 and measurement circuit 204, sensor 126, capacitive quantity sensing system 136 or system 100.

Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

According to one or more examples, process 600 includes performing a self-capacitance measurement of an electrode coupled to a housing structure while the housing structure receives a feed air stream to the internal chamber at operation 602. The performing a self-capacitance measurement may include performing a self-capacitance measurement process. Non-limiting examples of such a self-capacitance measurement process include a CVD type self-capacitance measurement or a charge-transfer self-capacitance measurement.

According to one or more examples, process 600 includes generating a value representing the self-capacitance of the electrode at least partially responsive to performing the self-capacitance measurement of the electrode at operation 604.

According to one or more examples, process 600 includes providing the value representing the self-capacitance of the electrode at operation 606.

According to one or more examples, process 600 optionally includes determining a quantity of particulate present in an internal chamber of a housing structure at least partially based on the value representing the self-capacitance of the electrode at operation 608.

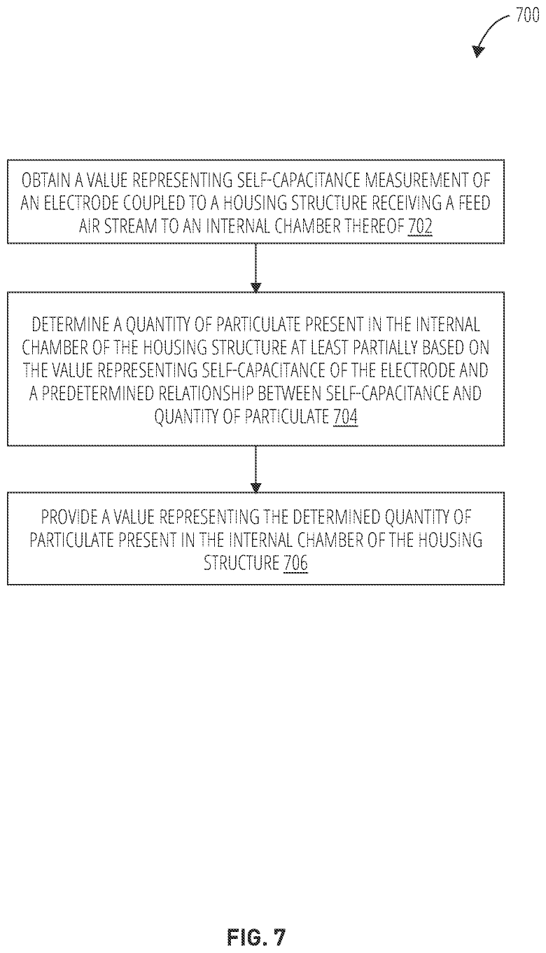

FIG. 7 is a flow diagram depicting a process 700 to capacitively determine a quantity of particulate present in an internal chamber of a housing structure, in accordance with one or more examples. Some or a totality of operations process 700 may be performed, as a non-limiting example, by logic circuit 130, apparatus 200, capacitive quantity sensing system 136, or system 100.

Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence.

According to one or more examples, process 700 includes obtaining a value representing self-capacitance measurement of an electrode coupled to a housing structure receiving a feed air stream to an internal chamber thereof at operation 702.

According to one or more examples, process 700 includes determining a quantity of particulate present in the internal chamber of the housing structure at least partially based on the value representing self-capacitance of the electrode and a predetermined relationship between self-capacitance and quantity of particulate at operation 704.

According to one or more examples, process 700 includes providing a value representing the determined quantity of particulate present in the internal chamber of the housing structure at operation 706.

Values representing quantity of particulate in an internal chamber may be utilized to determine one or more states of the internal chamber. Non-limiting examples of states may include empty, not empty, full, and not full. Such state information may be relevant to a specific application of the various examples discussed herein. As a non-limiting example, the state information may be relevant if internal chamber 104 is a monitored chamber and there is a safety or automatic shut-off switch to a source of a feed air stream 112 activated when the quantity of particulate is above a certain level. As another non-limiting example, such state information may be presented at a digital display (e.g., on a device, appliance, or industrial system including system 100 or a device in electronic communication (e.g., wired, wireless, both wired and wireless, without limitation) with system 100 such as a mobile device (e.g., a tablet computer, smart phone, wearable computer (e.g., a smart watch or band, without limitation), without limitation), a personal computer (e.g., a desktop computer, laptop computer, without limitation), a smart television, a dedicated appliance monitoring or control device, without limitation), a user interface, or combination thereof (e.g., a graphical user interface presented at a display of the device, appliance, or industrial system including system 100 or the device in electronic communication with system 100).

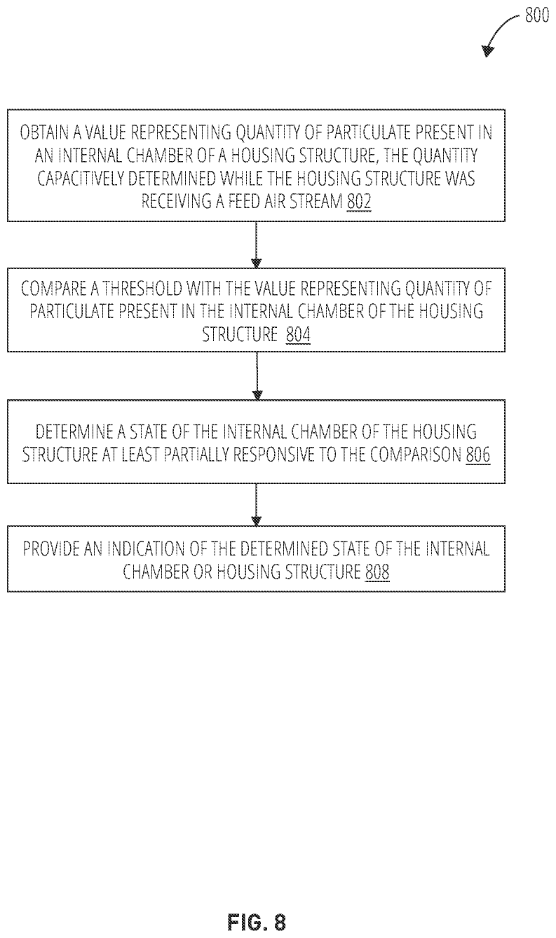

FIG. 8 is a flow diagram depicting a process 800 to determine a state of an internal chamber or housing structure, in accordance with one or more examples. Some or a totality of operations of process 800 may be performed, as non-limiting examples, by system 100, capacitive quantity sensing system 136, logic circuit 130, or apparatus 200, without limitation.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to one or more examples, process 800 includes obtaining a value representing quantity of particulate present in an internal chamber of a housing structure, the quantity capacitively determined while the housing structure was receiving a feed air stream at operation 802. In one or more examples, the value representing quantity of particulate present may be obtained responsive to process 500 or process 700.

According to one or more examples, process 800 includes comparing a threshold with the value representing quantity of particulate present in the internal chamber of the housing structure at operation 804. In one or more examples the threshold has a predetermined value. The value of the threshold may indicate a threshold quantity of particulate, where values above the threshold are associated with the internal chamber having at least a threshold quantity of particulate and values below the threshold are associated with the internal chamber having less than a threshold quantity of particulate.

According to one or more examples, process 800 includes determining a state of the internal chamber of the housing structure at least partially responsive to the comparison at operation 806. In one or more examples, the state of the internal chamber may be “full” or “not full.” In one or more examples, process 800 determines a full state in response to the comparison indicating the value representing quantity of particulate is greater than the threshold value. In one or more examples, process 800 determines a not full state in response to the comparison indicating the value representing quantity of particulate is less than or equal to the threshold value. The amount of particulate that corresponds to a full state or not-full state may, as a non-limiting example, depend on the application or operating conditions. Use of the term “full” is not intended imply that no particulate may be added to the chamber particulate or that the chamber particulate occupies the entire space of the internal chamber. Full is used to indicate a predetermined upper limit on the amount of particulate, which may include occupying the entire space, but is not limited to that. Use of other states in addition to or as an alternative to the states discussed above does not exceed the scope of this disclosure. As a non-limiting example, another threshold may be utilized to indicate a lower threshold limit below which the internal chamber is considered empty and above which the internal chamber is considered not empty.

According to one or more examples, process 800 includes providing an indication of the determined state of the internal chamber or housing structure at operation 808.

In some cases, the quantity of particulate in an internal chamber may be utilized to determine one or more states of the feed air stream. Non-limiting examples of states may include high flowrate, low flowrate, and no flowrate. Such state information may be relevant to an operating environment of system 100. As a non-limiting example, no flowrate or a low flowrate may indicate that an appliance or device is not operating suitably. As a non-limiting example, a vacuum cleaner may not be able to vacuum debris into its debris holding chamber unless the flow rate of the feed air stream is above a threshold.

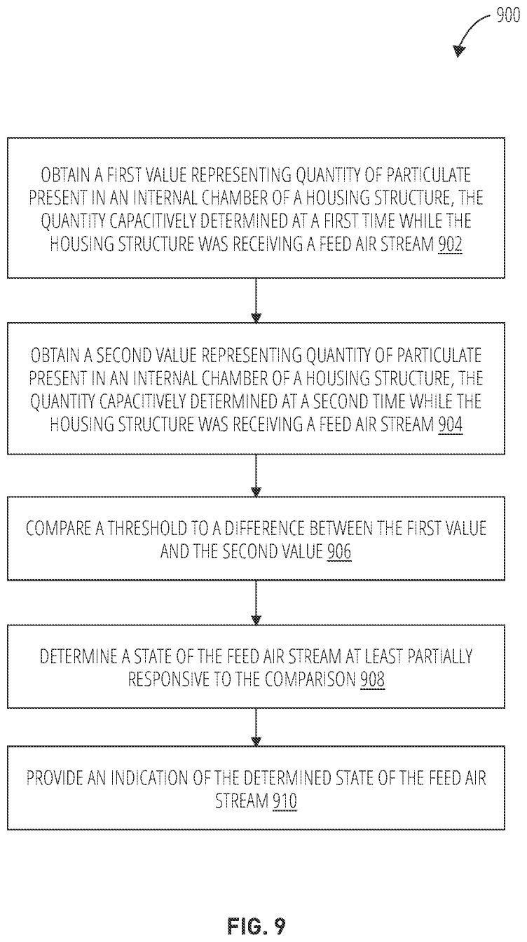

FIG. 9 is a flow diagram depicting a process 900 to determine a state of a feed air stream based on quantity of particulate, in accordance with one or more examples.

Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

According to some examples, process 900 includes obtaining a first value representing quantity of particulate present in an internal chamber of a housing structure, the quantity capacitively determined at a first time while the housing structure was receiving a feed air stream at operation 902. In one or more examples, the first value representing quantity of particulate may be obtained responsive to first performing a process 500 or a process 700.

According to some examples, process 900 includes obtaining a second value representing quantity of particulate present in an internal chamber of a housing structure, the quantity capacitively determined at a second time while the housing structure was receiving a feed air stream at operation 904. In one or more examples, the first value representing quantity of particulate may be obtained responsive to second performance of process 500 or of process 700, where the second performance of operation 904 and the first performance of operation 902 are performed at different times (e.g., at a first time and at a second time, which are different, without limitation).

According to some examples, process 900 includes comparing a threshold to a difference between the first value and the second value at operation 906. The difference between quantities of particulate present at the first time and the second time (which difference may also be characterized herein as a “change in quantity”) may indicate whether or not particulate is being added to the chamber particulate or a rate at which particulate is being added to the chamber particulate. In some examples, if particulate is not being added or the quantity is not increasing as expected, then that may indicate that the state of the feed air stream is a no flow or a low flow. In one or more examples, the threshold may be pre-set to one or more values respectively indicative of a no flow or a low flow for the feed air stream. As a non-limiting example, if the difference value is not equal to or greater than respective ones of the one or more threshold values then that would indicate potential no flow or low flow scenarios for the feed air stream.

Notably, a no flow or low flow scenario may also apply to an exhausted feed air stream 110. In one or more examples, a threshold value may be chosen that is indicative of either no flow or low flow of the feed air stream or exhausted feed air stream, in which case both could be checked and troubleshooted. In one or more examples, a first threshold value(s) may be chosen that is indicative of no flow or low flow for the feed air stream and second threshold value(s) may be chosen that are indicative of no flow or low flow for the exhausted feed air stream and respective states of the feed air stream or exhausted feed air stream may be determined at least partially based on.

By way of non-limiting example, flow above a threshold value may be caused by a missing or faulty filter, or by a faulty motor (e.g., a fan or blowing/sucking mechanism is over producing, without limitation) responsible for generating feed airstream or exhausted feed airstream. By way of non-limiting example, flow below a threshold value may be caused by a clogged filter, by an obstruction (e.g., a foreign object at least partially blocking a fluid pathway, without limitation), or a faulty motor (e.g., a fan or blowing/sucking mechanism is under producing, without limitation).

As noted herein, housing structure 102 may be or be a portion of a conduit structure and capacitive sensing system may be or a component of a flow rate sensor on the conduit structure. In such cases, the exhausted feed air stream is an air stream 110 expected to carry (e.g., out of internal chamber 104 via second port 108) some or a totality of particulate brought in by feed air stream 112. If the quantity value is, as non-limiting examples, increasing, increasing too quickly, or not decreasing then that may indicate that the state of the exhaust stream is no flow or low flow. In one or more examples, the threshold may be pre-set to one or more values respectively indicative of no flow or low flow for the exhaust air stream. As a non-limiting example, if the difference value is not equal to or less than respective ones of the one or more threshold values then that would indicate potential no flow or low flow scenario for the exhaust air stream.

According to some examples, process 900 includes determining a state of the feed air stream at least partially responsive to the comparison at operation 908. In one or more examples, the state of the feed air stream may be determined by comparing the difference between the obtained first value and the obtained second value to a threshold. In or more examples, the value of the threshold may be preset based on a known relationship between rate of change of quantity of particulate and flowrate of the feed air stream.

According to some examples, process 900 includes providing an indication of the determined state of the feed air stream at operation 910. As non-limiting examples, the indication may be provided to an audible or visual alert system, an automatic shut-off or appliance safety system,

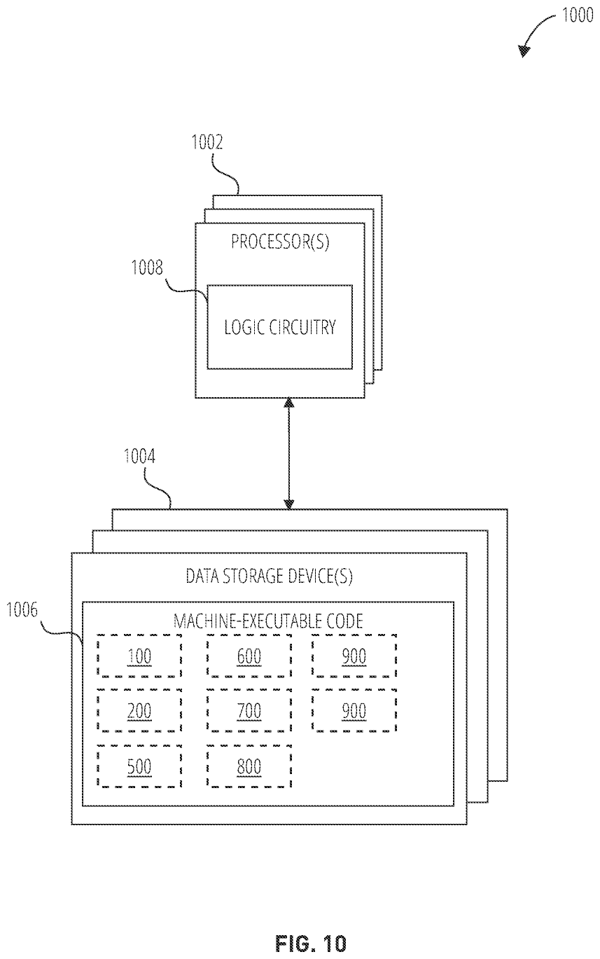

It will be appreciated by those of ordinary skill in the art that functional elements of examples disclosed herein (e.g., functions, operations, acts, processes, or methods) may be implemented in any suitable hardware, software, firmware, or combinations thereof. FIG. 10 illustrates non-limiting examples of implementations of functional elements disclosed herein. In some examples, some or all portions of the functional elements disclosed herein may be performed by hardware specially configured for carrying out the functional elements.

FIG. 10 is a block diagram of a circuitry 1000 that, in some examples, may be used to implement various functions, operations, acts, processes, or methods disclosed herein. The circuitry 1000 includes one or more processors 1002 (sometimes referred to herein as “processors 1002”) operably coupled to one or more data storage devices 1004 (sometimes referred to herein as “storage 1004”). The storage 1004 includes machine-executable code 1006 stored thereon and the processors 1002 include logic circuitry 1008. The machine-executable code 1006 information describes functional elements that may be implemented by (e.g., performed by) the logic circuitry 1008. The logic circuitry 1008 is adapted to implement (e.g., perform) the functional elements described by the machine-executable code 1006. The circuitry 1000, when executing the functional elements described by the machine-executable code 1006, should be considered as special purpose hardware configured for carrying out functional elements disclosed herein. In some examples the processors 1002 may be configured to perform the functional elements described by the machine-executable code 1006 sequentially, concurrently (e.g., on one or more different hardware platforms), or in one or more parallel process streams.

When implemented by logic circuitry 1008 of the processors 1002, the machine-executable code 1006 is configured to adapt the processors 1002 to perform operations of examples disclosed herein. By way of non-limiting example, the machine-executable code 1006 may be configured to adapt the processors 1002 to perform some or a totality of operations of processes discussed herein to determine quantity of aerated particulate present in an internal chamber of a housing structure.

Also by way of non-limiting example, the machine-executable code 1006 may be configured to adapt the processors 1002 to perform some or a totality of features, functions, or operations disclosed herein for one or more of: system 100 or apparatus 200, more specifically, features, functions, or operations disclosed herein for one or more of: electrode 122, sensor 126, logic circuit 130, acquisition circuit 202, or measurement circuit 204.

The processors 1002 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1006 (e.g., software code, firmware code, hardware descriptions) related to examples of the present disclosure. It is noted that a general-purpose processor (may also be referred to herein as a host processor or simply a host) may be a microprocessor, but in the alternative, the processors 1002 may include any conventional processor, controller, microcontroller, or state machine. The processors 1002 may also be implemented as a combination of computing devices, such as a combination of a DSP and a microprocessor, a plurality of microprocessors, one or more microprocessors in conjunction with a DSP core, or any other such configuration.

In some examples the storage 1004 includes volatile data storage (e.g., random-access memory (RAM)), non-volatile data storage (e.g., Flash memory, a hard disc drive, a solid state drive, erasable programmable read-only memory (EPROM), without limitation). In some examples the processors 1002 and the storage 1004 may be implemented into a single device (e.g., a semiconductor device product, a system on chip (SOC), without limitation). In some examples the processors 1002 and the storage 1004 may be implemented into separate devices.

In some examples the machine-executable code 1006 may include computer-readable instructions (e.g., software code, firmware code). By way of non-limiting example, the computer-readable instructions may be stored by the storage 1004, accessed directly by the processors 1002, and executed by the processors 1002 using at least the logic circuitry 1008. Also by way of non-limiting example, the computer-readable instructions may be stored on the storage 1004, transferred to a memory device (not shown) for execution, and executed by the processors 1002 using at least the logic circuitry 1008. Accordingly, in some examples the logic circuitry 1008 includes electrically configurable logic circuitry 1008.

In some examples the machine-executable code 1006 may describe hardware (e.g., circuitry) to be implemented in the logic circuitry 1008 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1008 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1006 may include an HDL, an RTL, a GL description, a mask level description, other hardware description, or any combination thereof.

In examples where the machine-executable code 1006 includes a hardware description (at any level of abstraction), a system (not shown, but including the storage 1004) may be configured to implement the hardware description described by the machine-executable code 1006. By way of non-limiting example, the processors 1002 may include a programmable logic device (e.g., an FPGA or a PLC) and the logic circuitry 1008 may be electrically controlled to implement circuitry corresponding to the hardware description into the logic circuitry 1008. Also by way of non-limiting example, the logic circuitry 1008 may include hard-wired logic manufactured by a manufacturing system (not shown but including the storage 1004) according to the hardware description of the machine-executable code 1006.

Regardless of whether the machine-executable code 1006 includes computer-readable instructions or a hardware description, the logic circuitry 1008 is adapted to perform the functional elements described by the machine-executable code 1006 when implementing the functional elements of the machine-executable code 1006. It is noted that although a hardware description may not directly describe functional elements, a hardware description indirectly describes functional elements that the hardware elements described by the hardware description are capable of performing.

Other types of capacitance may be observed and utilized to determine quantity of aerated particulate present in an internal chamber of a housing without exceeding the scope of this disclosure. As a non-limiting example, a person having ordinary skill in the art will appreciate that with appropriate changes to the number and arrangement of electrodes 122 coupled to external surface 118 of housing structure 102 sensor 126 may include logic to perform a mutual capacitance measurement. In response to one or more mutual capacitance measurements one or more electrodes 122 may exhibit mutual capacitance. Logic circuit 130 may include predetermined relationships between exhibited mutual capacitance and quantity of particulate present within internal chamber 104 of housing structure 102.

A further non-limiting example of a suitable acquisition process is to utilize a relaxation oscillator that oscillates with a frequency indicative of an associated mutual capacitance. Another non-limiting example of a suitable technique is utilization of a circuit that tracks the time to charge a capacitance of a sensor node to a predetermined voltage or an amount a sensor node is charged over a predetermined period of time—time to charge or amount charged being indicative of mutual capacitance. Another non-limiting example of a suitable acquisition process is to utilize a charge transfer circuit that accumulates charge onto an integrating capacitor and the voltage across the integrating capacitor, which is indicative of mutual capacitance, is compared to a reference voltage or read by an analog-to-digital converter for comparison to a threshold value. Another non-limiting example of a suitable acquisition process is utilization of sigma-delta modulation where a voltage across an external capacitor is modulated about a reference voltage in charge-up and charge-down operations and the time duration of these operations is indicative of mutual capacitance.

A person having ordinary skill in the art will appreciate many advantages of disclosed examples and applications to utilize disclosed examples. As a non-limiting example, a fill sensor on a reusable or disposable canister or bag for collecting and holding particulate gathered by a particulate collector such as a vacuum system or air filtration system, without limitation, that notifies a user when it detects a threshold amount of fill within the canister or bag. As a non-limiting example, an air flow rate sensor on a conduit structure for transferring an air stream through a hollow of the conduit structure that notifies a user when it detects a threshold amount of fill within a hollow of the conduit structure, the threshold amount of fill associated with reduced or unsuitable air flow rate. Disclosed examples may be utilized in consumer appliance applications, industrial process and system application, or automotive applications, without limitation. Other applications do not exceed the scope of this disclosure.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A system, comprising: a housing structure to receive a feed air stream into an internal chamber thereof; an electrode coupled to the housing structure; a sensor to generate a value representative of self-capacitance of the electrode; and a logic circuit to determine a value representative of quantity of particulate present within the internal chamber of the housing structure at least partially based on the value representative of self-capacitance of the electrode.

Example 2: The system according to Example 1, wherein the logic circuit to determine the value representative of quantity of particulate while the housing structure is receiving the feed air stream into the internal chamber.

Example 3: The system according to any of Examples 1 and 2, wherein the logic circuit to determine the value representative of quantity of particulate while at least a portion of particulate within the internal chamber of the housing structure is at least partially aerated by the feed air stream.

Example 4: The system according to any of Examples 1 through 3, wherein the logic circuit to determine the value indicative of quantity of particulate while the feed air stream is received into the internal chamber of the housing structure.

Example 5: The system according to any of Examples 1 through 4, wherein the sensor to generate the value representative of self-capacitance of the electrode while aerated particulate is present in the internal chamber of the housing structure.

Example 6: The system according to any of Examples 1 through 5, wherein the sensor to generate the value representative of self-capacitance of the electrode while the feed air stream is received into the internal chamber of the housing structure.

Example 7: The system according to any of Examples 1 through 6, wherein the electrode is affixed to an external surface of the housing.

Example 8: The system according to any of Examples 1 through 7, wherein the electrode is positioned to orient a longest length of the electrode in a direction parallel to a height of the housing structure.

Example 9: The system according to any of Examples 1 through 8, wherein the electrode is positioned to orient a longest length of the electrode in a direction perpendicular to a height of the housing structure.

Example 10: The system according to any of Examples 1 through 9, wherein the electrode is positioned to orient a longest length of the electrode in a direction at an angle with respect to height or width of the housing structure.

Example 11: The system according to any of Examples 1 through 10, wherein the internal chamber of the housing defines a volume having a cylindrical geometry.

Example 12: The system according to any of Examples 1 through 11, wherein the internal chamber of the housing defines a volume having a rectangular geometry.

Example 13: The system according to any of Examples 1 through 12, wherein a particulate material of the particulate is non-uniform.

Example 14: The system according to any of Examples 1 through 13, wherein a particulate material of the particulate is uniform.

Example 15: The system according to any of Examples 1 through 14, wherein the sensor comprises: an acquisition circuit to generate an internal voltage indicative of a capacitance of the electrode responsive to a capacitive measurement process; and a measurement circuit to generate the value representative of self-capacitance of the electrode at least partially responsive to the internal voltage.

Example 16: The system according to any of Examples 1 through 15, wherein the housing comprises: a first port to receive the feed air stream into the internal chamber, and a second port to expel exhausted air stream.

Example 17: The system according to any of Examples 1 through 16, wherein the internal chamber configured to circulate the feed air stream therein.

Example 18: A system, comprising: a housing structure having an internal chamber; and a capacitive quantity sensing system to capacitively determine a quantity of particulate present in the internal chamber of a housing structure coupled to an electrode while the housing structure receives a feed air stream to the internal chamber.

Example 19: The system according to Example 18, wherein the capacitive quantity sensing system includes a sensor to: perform a self-capacitance measurement of an electrode coupled to a housing structure while the housing structure receives a feed air stream to the internal chamber; generate a value representing the self-capacitance of the electrode at least partially responsive to performing the self-capacitance measurement of the electrode; and provide the value representing the self-capacitance of the electrode.

Example 20: The system according to any of Examples 18 and 19, wherein the capacitive quantity sensing system includes a logic circuit to: obtain a value representing self-capacitance measurement of an electrode coupled to a housing structure receiving a feed air stream to an internal chamber thereof; determine a quantity of particulate present in the internal chamber of the housing structure at least partially based on the value representing self-capacitance of the electrode and a predetermined relationship between self-capacitance and quantity of particulate; and provide a value representing the determined quantity of particulate present in the internal chamber of the housing structure.

Example 21: The system according to any of Examples 18 through 20, comprising a logic circuit to: obtain a value representing quantity of particulate present in an internal chamber of a housing structure, the quantity capacitively determined while the housing structure was receiving a feed air stream; compare a threshold with the value representing quantity of particulate present in the internal chamber of the housing structure; determine a state of the internal chamber of the housing structure at least partially responsive to the comparison; and provide an indication of the determined state of the internal chamber or housing structure.

Example 22: The system according to any of Examples 18 through 21, comprising a logic circuit to: obtain a first value representing quantity of particulate present in an internal chamber of a housing structure, the quantity capacitively determined at a first time while the housing structure was receiving a feed air stream; obtain a second value representing quantity of particulate present in an internal chamber of a housing structure, the quantity capacitively determined at a second time while the housing structure was receiving the feed air stream; compare a threshold to a difference between the first value and the second value; determine a state of the feed air stream at least partially responsive to the comparison; and provide an indication of the determined state of the feed air stream.

Example 23: A method, comprising: capacitively determining a quantity of particulate present in an internal chamber of a housing structure while the housing structure receives a feed air stream to the internal chamber; and providing a value representing a measured quantity of particulate.

Example 24: The method according to Example 23, wherein capacitively determining the quantity of particulate present in the internal chamber of a housing structure comprises: obtaining a value representing self-capacitance measurement of an electrode coupled to a housing structure receiving a feed air stream to an internal chamber thereof; determining a quantity of particulate present in the internal chamber of the housing structure at least partially based on the value representing self-capacitance of the electrode and a predetermined relationship between self-capacitance and quantity of particulate; and providing a value representing the determined quantity of particulate present in the internal chamber of the housing structure.

Example 25: The method according to any of Examples 23 and 24, wherein obtaining the value representing self-capacitance measurement of an electrode comprises; performing a self-capacitance measurement of an electrode coupled to a housing structure while the housing structure receives a feed air stream to the internal chamber; and obtaining a value representing the self-capacitance of the electrode at least partially responsive to performing the self-capacitance measurement of the electrode.

Example 26: The method according to any of Examples 23 through 25, comprising: obtaining a value representing the quantity of particulate present in the internal chamber of the housing structure, the quantity capacitively determined while the housing structure was receiving the feed air stream to the internal chamber; comparing a threshold with the value representing the quantity of particulate present in the internal chamber of the housing structure; determining a state of the internal chamber of the housing structure at least partially responsive to the comparison; and providing an indication of the determined state of the internal chamber or housing structure.

Example 27: The method according to any of Examples 23 through 26, comprising: obtaining a first value representing the quantity of particulate present in the internal chamber of the housing structure, the quantity capacitively determined at a first time while the housing structure was receiving the feed air stream to the internal chamber; obtaining a second value representing the quantity of particulate present in the internal chamber of the housing structure, the quantity capacitively determined at a second time while the housing structure was receiving the feed air stream to the internal chamber; and determining a state of the feed air stream or an exhausted feed air stream at least partially responsive to a difference between the first value and the second value.

Example 28: The method according to any of Examples 23 through 27, wherein the determining the state of the feed air stream or the exhausted feed air stream at least partially responsive to the difference between the first value and the second value comprises: comparing a threshold to the difference between the first value and the second value; and determining the state of the feed air stream or the exhausted feed air stream at least partially responsive to the comparison.

Example 29: The method according to any of Examples 23 through 28, comprising: providing an indication of the determined state of the feed air stream or the exhausted feed air stream.

Example 30: The method according to any of Examples 23 through 29, comprising: providing, to a user interface, information about the state of the feed air stream or the exhausted feed air stream at least partially responsive to an indication of the determined state of the feed air stream or the exhausted feed air stream.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A system, comprising:
a housing structure to receive a feed air stream into an internal chamber thereof;
an electrode coupled to the housing structure;
a sensor to generate a value representative of self-capacitance of the electrode; and
a logic circuit to determine a value representative of quantity of particulate present within the internal chamber of the housing structure at least partially based on the value representative of self-capacitance of the electrode.

2. The system of claim 1, wherein the logic circuit to determine the value representative of quantity of particulate while the housing structure is receiving the feed air stream into the internal chamber.

3. The system of claim 1, wherein the logic circuit to determine the value representative of quantity of particulate while at least a portion of particulate within the internal chamber of the housing structure is at least partially aerated by the feed air stream.

4. The system of claim 1, wherein the logic circuit to determine the value indicative of quantity of particulate while the feed air stream is received into the internal chamber of the housing structure.

5. The system of claim 1, wherein the sensor to generate the value representative of self-capacitance of the electrode while aerated particulate is present in the internal chamber of the housing structure.

6. The system of claim 1, wherein the sensor to generate the value representative of self-capacitance of the electrode while the feed air stream is received into the internal chamber of the housing structure.

7. The system of claim 1, wherein the electrode is affixed to an external surface of the housing.

8. The system of claim 1, wherein the electrode is positioned to orient a longest length of the electrode in a direction parallel to a height of the housing structure.

9. The system of claim 1, wherein the electrode is positioned to orient a longest length of the electrode in a direction perpendicular to a height of the housing structure.

10. The system of claim 1, wherein the electrode is positioned to orient a longest length of the electrode in a direction at an angle with respect to height or width of the housing structure.

11. The system of claim 1, wherein the internal chamber of the housing defines a volume having a cylindrical geometry.

12. The system of claim 1, wherein the internal chamber of the housing defines a volume having a rectangular geometry.

13. The system of claim 1, wherein a particulate material of the particulate is non-uniform.

14. The system of claim 1, wherein a particulate material of the particulate is uniform.

15. The system of claim 1, wherein the sensor comprises:
an acquisition circuit to generate an internal voltage indicative of a capacitance of the electrode responsive to a capacitive measurement process; and
a measurement circuit to generate the value representative of self-capacitance of the electrode at least partially responsive to the internal voltage.

16. The system of claim 1, wherein the housing comprises:
a first port to receive the feed air stream into the internal chamber, and
a second port to expel exhausted air stream.

17. The system of claim 16, wherein the internal chamber configured to circulate the feed air stream therein.

18. A system, comprising:
a housing structure having an internal chamber; and
a capacitive quantity sensing system to capacitively determine a quantity of particulate present in the internal chamber of a housing structure coupled to an electrode while the housing structure receives a feed air stream to the internal chamber.

19. The system of claim 18, wherein the capacitive quantity sensing system includes a sensor to:
perform a self-capacitance measurement of an electrode coupled to a housing structure while the housing structure receives a feed air stream to the internal chamber;
generate a value representing the self-capacitance of the electrode at least partially responsive to performing the self-capacitance measurement of the electrode; and
provide the value representing the self-capacitance of the electrode.

20. The system of claim 18, wherein the capacitive quantity sensing system includes a logic circuit to:
obtain a value representing self-capacitance measurement of an electrode coupled to a housing structure receiving a feed air stream to an internal chamber thereof;
determine a quantity of particulate present in the internal chamber of the housing structure at least partially based on the value representing self-capacitance of the electrode and a predetermined relationship between self-capacitance and quantity of particulate; and
provide a value representing the determined quantity of particulate present in the internal chamber of the housing structure.

21. The system of claim 18, comprising a logic circuit to:
obtain a value representing quantity of particulate present in an internal chamber of a housing structure, the quantity capacitively determined while the housing structure was receiving a feed air stream;
compare a threshold with the value representing quantity of particulate present in the internal chamber of the housing structure;
determine a state of the internal chamber of the housing structure at least partially responsive to the comparison; and
provide an indication of the determined state of the internal chamber or housing structure.

22. The system of claim 18, comprising a logic circuit to:
obtain a first value representing quantity of particulate present in an internal chamber of a housing structure, the quantity capacitively determined at a first time while the housing structure was receiving a feed air stream;
obtain a second value representing quantity of particulate present in an internal chamber of a housing structure, the quantity capacitively determined at a second time while the housing structure was receiving the feed air stream;
compare a threshold to a difference between the first value and the second value;
determine a state of the feed air stream at least partially responsive to the comparison; and
provide an indication of the determined state of the feed air stream.

23. A method, comprising:
capacitively determining a quantity of particulate present in an internal chamber of a housing structure while the housing structure receives a feed air stream to the internal chamber; and
providing a value representing a measured quantity of particulate.

24. The method of claim 23, wherein capacitively determining the quantity of particulate present in the internal chamber of a housing structure comprises:
obtaining a value representing self-capacitance measurement of an electrode coupled to a housing structure receiving a feed air stream to an internal chamber thereof;
determining a quantity of particulate present in the internal chamber of the housing structure at least partially based on the value representing self-capacitance of the electrode and a predetermined relationship between self-capacitance and quantity of particulate; and
providing a value representing the determined quantity of particulate present in the internal chamber of the housing structure.

25. The method of claim 23, wherein obtaining the value representing self-capacitance measurement of an electrode comprises;
performing a self-capacitance measurement of an electrode coupled to a housing structure while the housing structure receives a feed air stream to the internal chamber; and
obtaining a value representing the self-capacitance of the electrode at least partially responsive to performing the self-capacitance measurement of the electrode.

26. The method of claim 23, comprising:
obtaining a value representing the quantity of particulate present in the internal chamber of the housing structure, the quantity capacitively determined while the housing structure was receiving the feed air stream to the internal chamber;
comparing a threshold with the value representing the quantity of particulate present in the internal chamber of the housing structure;
determining a state of the internal chamber of the housing structure at least partially responsive to the comparison; and
providing an indication of the determined state of the internal chamber or housing structure.

27. The method of claim 23, comprising:
obtaining a first value representing the quantity of particulate present in the internal chamber of the housing structure, the quantity capacitively determined at a first time while the housing structure was receiving the feed air stream to the internal chamber;
obtaining a second value representing the quantity of particulate present in the internal chamber of the housing structure, the quantity capacitively determined at a second time while the housing structure was receiving the feed air stream to the internal chamber; and
determining a state of the feed air stream or an exhausted feed air stream at least partially responsive to a difference between the first value and the second value.

28. The method of claim 27, wherein the determining the state of the feed air stream or the exhausted feed air stream at least partially responsive to the difference between the first value and the second value comprises:
comparing a threshold to the difference between the first value and the second value; and
determining the state of the feed air stream or the exhausted feed air stream at least partially responsive to the comparison.

29. The method of claim 27, comprising: providing an indication of the determined state of the feed air stream or the exhausted feed air stream.

30. The method of claim 27, comprising: providing, to a user interface, information about the state of the feed air stream or the exhausted feed air stream at least partially responsive to an indication of the determined state of the feed air stream or the exhausted feed air stream.
